(19) United States
(12) Patent Application Publication
(10) Pub. No.: US 2012/0298348 A1
(43) Pub. Date: Nov. 29, 2012

(54) AIR-CONDITIONING CONTROL DEVICE, AIR-CONDITIONING SYSTEM, AND AIR-CONDITIONING CONTROL METHOD

(75) Inventors: Atsushi Mise, Osaka (JP); Akio Nakano, Osaka (JP); Takashi Nishiyama, Hyogo (JP); Shinpei Hibiya, Osaka (JP)

(73) Assignee: PANASONIC CORPORATION, Osaka (JP)

(21) Appl. No.: 13/574,880

(22) PCT Filed: Jan. 14, 2011
(86) PCT No.: PCT/JP2011/050496

§ 371 Date: Aug. 9, 2012

(30) Foreign Application Priority Data
Jan. 26, 2010 (JP) 2010-014759

(51) Int. Cl. G05D 23/00

(52) U.S. Cl. 165/287

(57) ABSTRACT

The air-conditioning control device controls an air conditioner for changing an air temperature within an area, and includes a manipulation unit for inputting a required temperature; an adequate temperature setting unit for calculating an adequate temperature defined as a comfortable temperature for a user in the area using comfort evaluation; a control unit for performing selectively a first mode of controlling the conditioner to adjust the air temperature to the required temperature and a second mode of controlling the conditioner to adjust the air temperature to the adequate temperature; and a judging unit for judging whether or not a switching condition is fulfilled while the control unit performs the first mode. The control unit performs the first mode when the required temperature is inputted via the manipulation unit, and ends the first mode and starts the second mode when the judging unit judges that the switching condition is fulfilled

### TECHNICAL FIELD

The present invention relates to an air-conditioning control device for controlling an air conditioner designed to change an air temperature within an area (residential space) as an air-conditioned target, an air-conditioning system using the same, and an air-conditioning control method.

### BACKGROUND ART

In the past, there has been proposed, as an air-conditioning control device for controlling an air conditioner designed to change an air temperature within a space to be air-conditioned, a device for adjusting a designated temperature of an air conditioner to a required value (required temperature) in response to a request from a user (see e.g., JP 2008-241151 A). The air conditioner controlled by this air-conditioning control system operates to adjust, to the required temperature (designated temperature), an air temperature of the space as an air-conditioned target.

However, when the air conditioner continues operating to adjust the air temperature of the space as the air-conditioned target to the required temperature, as shown in FIG. 17 (a) to (c), the air temperature (room temperature in FIG. 17 (c)) becomes a temperature corresponding to a thermal sensation of the user at the time (time t51) at which the required temperature is inputted. Consequently, the prior air-conditioning control device is likely to cause excess cooling (or excess heating) to the space as the air-conditioned target, and therefore may decrease comfort of the user (FIGS. 17 (b) and (c)). Further, with regard to the prior control device, the excess cooling (or excess heating) to the space to be air-conditioned causes an increase in energy consumed by the air conditioner.

In view of the above insufficiency, it is considered to use, as the air-conditioning control device, a device configured to select, as the adequate temperature, a temperature at which the thermal sensation value of the user is a value indicative of neutral, and to control the air conditioner to adjust the temperature of the space as the air-conditioned target to the adequate temperature.

However, as shown in FIG. 18 (a) to (c), the above air-conditioning control device may have a new disadvantage that it takes a long time for the thermal sensation value of the user to become equal to the value (0) indicative of neutral.

### DISCLOSURE OF INVENTION

In view of the above insufficiency, the present invention has been aimed to propose an air-conditioning control device, an air-conditioning system, and an air-conditioning control method which are capable of changing condition of an area to be air-conditioned to highly comfortable condition in a short time and decreasing consumption energy of an air conditioner.

The air-conditioning control device of the first aspect in accordance with the present invention is configured to control an air conditioner designed to change an air temperature within an area. The air-conditioning control device includes a manipulation unit, an adequate temperature setting unit, a control unit, and a judging unit. The manipulation unit is designed for inputting a required temperature. The adequate temperature setting unit is configured to calculate an adequate temperature defined as a comfortable temperature for a user in the area on the basis of comfort evaluation. The control unit is configured to perform selectively a first mode of controlling the air conditioner to adjust the air temperature to the required temperature and a second mode of controlling the air conditioner to adjust the air temperature to the adequate temperature. The judging unit is configured to judge whether or not a switching condition is fulfilled while the control unit performs the first mode. The control unit is configured to, when the required temperature is inputted via the manipulation unit, perform the first mode. The control unit is configured to, when the judging unit judges that the switching condition is fulfilled, end the first mode and start the second mode.

In the air-conditioning control device of the second aspect in accordance with the present invention, in addition to the first aspect, the air-conditioning control device further includes a condition setting unit. The condition setting unit is configured to calculate a switching time. The switching time is defined as time which it takes for the user to feel comfortable from the time of input of the required temperature via the manipulation unit. The judging unit is configured to, upon acknowledging that elapsed time from the time of input of the required temperature via the manipulation unit exceeds the switching time, judge that the switching condition is fulfilled.

In the air-conditioning control device of the third aspect in accordance with the present invention, in addition to the second aspect, the adequate temperature setting unit is configured to select, as the adequate temperature, a temperature at which a thermal sensation value of the user becomes a value indicative of neutral. The switching time is defined as time which it takes for the thermal sensation value of the user to become the value indicative of neutral from the time of input of the required temperature via the manipulation unit.

In the air-conditioning control device of the fourth aspect in accordance with the present invention, in addition to the second aspect, the condition setting unit is configured to adjust the switching time by use of a parameter indicative of external environment of the area.

In the air-conditioning control device of the fifth aspect in accordance with the present invention, in addition to the second aspect, the condition setting unit is configured to adjust the switching time by use of a working level of the user existing in the area.

In the air-conditioning control device of the sixth aspect in accordance with the present invention, in addition to the second aspect, the condition setting unit is configured to adjust the switching time by use of an activity level of the user existing in the area.

In the air-conditioning control device of the seventh aspect in accordance with the present invention, in addition to the first aspect, the air-conditioning control device further includes a condition setting unit. The condition setting unit is configured to select the switching condition in accordance with biological information of the user existing in the area.

In the air-conditioning control device of the eighth aspect in accordance with the present invention, in addition to the first aspect, the air-conditioning control device further includes a condition setting unit. The condition setting unit is configured to estimate a current thermal sensation value of the user existing in the area. The judging unit is configured to, upon acknowledging that the current thermal sensation value of the user existing in the area estimated by the condition setting unit becomes a value indicative of neutral, judge that the switching condition is fulfilled.

In the air-conditioning control device of the ninth aspect in accordance with the present invention, in addition to the first aspect, the air conditioning control device further includes a condition setting unit configured to select the switching condition in accordance with agreement made by a plurality of users existing in the area.

In the air-conditioning control device of the tenth aspect in accordance with the present invention, in addition to the first aspect, the air-conditioning control device further includes a condition setting unit. The condition setting unit is configured to calculate a ratio of users feeling uncomfortable to all users. The judging unit is configured to, upon acknowledging that the ratio of users feeling uncomfortable to all users calculated by the condition setting unit exceeds a threshold value, judge that the switching condition is fulfilled.

In the air-conditioning control device of the eleventh aspect in accordance with the present invention, in addition to any one of the first to tenth aspects, the adequate temperature setting unit is configured to calculate a temperature range comfortable for the user existing in the area on the basis of the comfort evaluation, and select a temperature from the temperature range as the adequate temperature.

In the air-conditioning control device of the twelfth aspect in accordance with the present invention, in addition to the eleventh aspect, the adequate temperature setting unit is configured to select, as the adequate temperature, a temperature at which consumption energy of the air conditioner is minimized within the temperature range.

In the air-conditioning control device of the thirteenth aspect in accordance with the present invention, in addition to any one of the first to twelfth aspects, the air-conditioning control device further includes an announcing unit configured to announce, to the user existing in the area, information for relieving dissatisfaction against comfort.

The air-conditioning system in accordance with the present invention includes an air conditioner designed to change an air temperature within an area and an air-conditioning control device configured to control the air conditioner. The air-conditioning control device is defined by any one of the first to thirteenth aspects.

The air-conditioning control method in accordance with the present invention is a method for controlling an air conditioner designed to change an air temperature within an area. The air-conditioning control method includes the steps of: receiving a required temperature; calculating an adequate temperature defined as a comfortable temperature for a user in the area on the basis of comfort evaluation; controlling the air conditioner to adjust the air temperature to the required temperature in response to receipt of the desired temperature; judging whether or not a switching condition is fulfilled while the air conditioner is controlled to adjust the air temperature to the required temperature; and controlling the air conditioner to adjust the air temperature to the adequate temperature when the switching condition is fulfilled.

### BRIEF DESCRIPTION OF DRAWINGS

FIG. 1 is a block diagram illustrating a configuration of the air-conditioning system of the first embodiment,

FIG. 2 is a flowchart illustrating the air-conditioning control method using the above air-conditioning system,

FIG. 3 relates to the above air-conditioning system, and shows a diagram (a) illustrating a designated temperature of an air conditioner, a diagram (b) illustrating a thermal sensation value, and a diagram (c) illustrating an actual room temperature,

FIG. 4 is a flowchart illustrating the air-conditioning control method using a modification of the above air-conditioning system,

FIG. 5 is a flowchart illustrating the air-conditioning control method using the air-conditioning system of the second embodiment,

FIG. 6 is a flowchart illustrating the air-conditioning control method using a modification of the above air-conditioning system,

FIG. 7 is a flowchart illustrating the air-conditioning control method using the air-conditioning system of the third embodiment,

FIG. 8 is a flowchart illustrating the air-conditioning control method using the air-conditioning system of the forth embodiment,

FIG. 9 relates to the above air-conditioning system, and shows a diagram (a) illustrating the designated temperature of the air conditioner, a diagram (b) illustrating the thermal sensation value, and a diagram (c) illustrating the actual room temperature,

FIG. 10 is a flowchart illustrating the air-conditioning control method using the air-conditioning system of the fifth embodiment,

FIG. 11 is a flowchart illustrating the air-conditioning control method using a modification of the above air-conditioning system,

FIG. 12 relates to the above air-conditioning system, and shows a diagram (a) illustrating characteristics of the designated temperature of the air conditioner, a diagram (b) illustrating an air flow rate of the air conditioner, a diagram (c) illustrating the thermal sensation value, and a diagram (d) illustrating the actual room temperature,

FIG. 13 is a flowchart illustrating the air-conditioning control method using another modification of the above air-conditioning system,

FIG. 14 relates to the above air-conditioning system, and shows a diagram (a) illustrating the designated temperature of the air conditioner, a diagram (b) illustrating output electric power of the air conditioner, a diagram (c) illustrating the thermal sensation value, and a diagram (d) illustrating the actual room temperature,

FIG. 15 is a flowchart illustrating the air-conditioning control method using the air-conditioning system of the sixth embodiment,

FIG. 16 relates to the above air-conditioning system, and shows a diagram (a) illustrating the designated temperature of the air conditioner, a diagram (b) illustrating the thermal sensation value, and a diagram (c) illustrating the actual room temperature,

FIG. 17 relates to a prior air-conditioning system, and shows a diagram (a) illustrating the designated temperature of the air conditioner, a diagram (b) illustrating the thermal sensation value, and a diagram (c) illustrating the actual room temperature, and

FIG. 18 relates to another prior air-conditioning system, and shows a diagram (a) illustrating the designated temperature of the air conditioner, a diagram (b) illustrating the thermal sensation value, and a diagram (c) illustrating the actual room temperature,

### BEST MODE FOR CARRYING OUT THE INVENTION

### First Embodiment

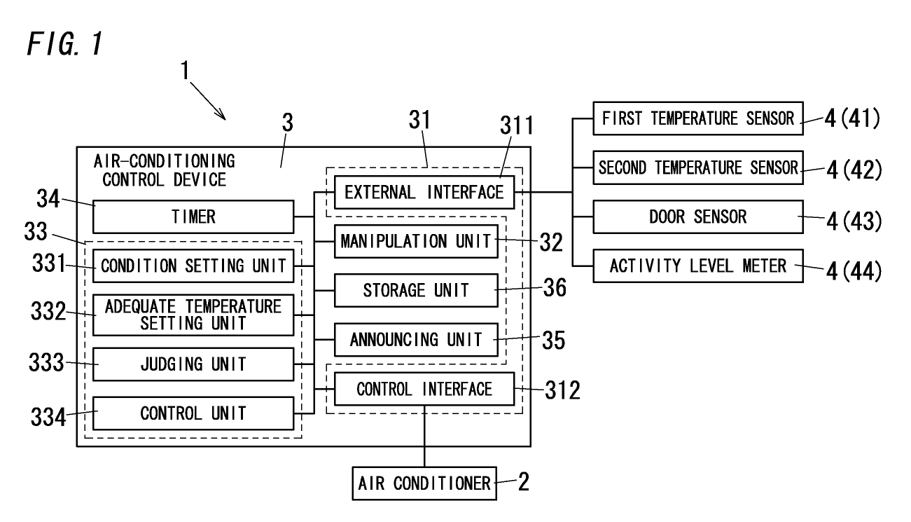

As shown in FIG. 1, the air-conditioning system 1 of the first embodiment includes an air conditioner 2 designed to change an air temperature within an area (residential space) to be air-conditioned and an air-conditioning control device 3 configured to control the air conditioner 2. In the following explanation of the present embodiment, the area to be air-conditioned is a room inside (indoor space) of a building.

The air-conditioning control device 3 includes an input-output interface 31, a manipulation unit 32, a calculation unit 33, a timer 34, an announcing unit 35, and a storage unit (memory) 36.

The input-output interface 31 includes an external interface 311 and a control interface 312.

The external interface 311 is configured to receive information outputted from an external device 4, and output the received information to appropriate units of the air-conditioning control device 3.

The external devices 4 include a first temperature sensor 41, a second temperature sensor 42, a door sensor 43, and an activity level meter 44, for example. The first temperature sensor 41 is configured to measure a temperature (hereinafter referred to as “room temperature”) of the indoor space. The second temperature sensor 42 is configured to measure a temperature (hereinafter referred to as “outdoor temperature”) of an outside. The door sensor 43 is configured to judge whether or not a door positioned between the indoor space and the outside is opened. The activity level meter 44 is attached to a user, and is configured to measure an activity level of the user.

The control interface 312 is configured to output a control signal. The control signal includes control information from a control unit 334 to be described.

The manipulation unit 32 is designed for inputting a required temperature. For example, the manipulation unit 32 is constituted by a plurality of manual buttons or a touch panel. In response to manipulation of the user, a required value of the room temperature is inputted into the manipulation unit 32 as the required temperature. In brief, a designated temperature of the air conditioner 2 is inputted into the manipulation unit 32. In addition to the required temperature, a working level, a metabolic rate, and an amount of clothing of the user are inputted into the manipulation unit 32 in response to manipulation of the user, for example. The working level of the user include a strong level, a normal level, and a weak level, for example. The inputted information (e.g., the required temperature, the working level of the user, the metabolic rate of the user, and the amount of clothing of the user) is outputted from the manipulation unit 32 to the calculation unit 33 and is stored in the storage unit 36.

The calculation unit 33 includes a condition setting unit 331, an adequate temperature setting unit 332, a judging unit 333, and the control unit 334. The calculation unit 33 is constructed by use of a central processing unit (CPU) of a microcomputer, for example.

The condition setting unit 331 uses, for a switching condition, time which it takes for a thermal sensation value to become a value indicative of neutral (comfortable state) from time (hereinafter referred to as “switching time”) at which the required temperature is inputted into the manipulation unit 32. In brief, the condition setting unit 331 calculates the switching time as a judging value used for judgment of whether or not the switching condition is fulfilled. The switching time is defined as time which it takes for the thermal sensation value of the user in the area to become the value indicative of neutral from the time of input of the required temperature via the manipulation unit 32. The adequate temperature is defined as a comfortable temperature for a user in the area. For example, the adequate temperature is defined as a temperature at which the thermal sensation value of the user becomes the value indicative of neutral. That is, the switching time is defined as time which it takes for the user to feel comfortable from the time of input of the required temperature via the manipulation unit 32. The condition setting unit 331 obtains the room temperature from the first temperature sensor 41 via the external interface 311. The condition setting unit 331 applies the room temperature and the required temperature to a basic formula stored in the storage unit 36, thereby, calculating the switching time. For example, the basic formula is prepared based on results of experimentation preliminarily performed in an environment. Besides, the condition setting unit 331 may calculate the switching time by use of a table indicative of a relation between the switching time and a combination of the room temperature and the required temperature, instead of the basic formula. In brief, the condition setting unit 331 may be configured to determine the switching time by use of a predetermined rule. The basic formula or the table may be stored in the storage unit 36.

Further, the condition setting unit 331 is configured to adjust the calculated switching time by use of a parameter indicative of an external environment of the indoor space, the working level of the user, and the activity level of the user which is measured before the user comes into the indoor space. For example, the parameter indicative of the external environment of the indoor space may be selected from the outdoor temperature, and time during which the door is opened (that is, time (hereinafter referred to as “exposed time”) during which the indoor space is exposed to the outside). The condition setting unit 331 obtains, via the external interface 311, the outdoor temperature from the second temperature sensor 42, opening and closing information from the door sensor 43, and the activity level of the user which is measured before the user comes into the indoor space from the active mass meter 44. The condition setting unit 331 calculates the exposed time by use of the opening and closing information obtained from the door sensor 43 and the timer 34. Further, the condition setting unit 331 obtains the working level of the user in response to manipulation of the manipulation unit 32 by the user.

The adequate temperature setting unit 332 is configured to calculate the adequate temperature on the basis of thermal comfort evaluation. The adequate temperature setting unit 332 of the present embodiment has a selection function of determining a temperature range on the basis of the comfort evaluation and a setting function of selecting a particular temperature of the temperature range as the adequate temperature. In other words, the adequate temperature setting unit 332 is configured to calculate the temperature range comfortable for the user existing in the area on the basis of the comfort evaluation, and select a temperature from the temperature range as the adequate temperature. The adequate temperature setting unit 332 is configured to select, as the adequate temperature, a temperature at which consumption energy of the air conditioner 2 is minimized within the temperature range while performing the setting function. The adequate temperature decided by the adequate temperature setting unit 332 is stored in the storage unit 36.

In the present embodiment, the Predicted Mean Vote (PMV) value is adopted as the comfort evaluation. The predicted mean vote is calculated by use of the room temperature, air speed, a mean radiant temperature, relative humidity, the metabolic rate of the user, the amount of clothing of the user. The objective comfort becomes higher as the PMV value is closer to 0. Generally, the comfort is considered to be high while the PMV value is in a range of −0.5 to +0.5. Meanwhile, the user feels hotter with an increase in the PMV value. The user feels colder with a decrease in the PMV value.

The judging unit 333 is configured to judge whether or not the switching condition is fulfilled. For example, the judging unit 333 is configured to measure, by use of the timer 34, time (elapsed time from the time of input of the required temperature via the manipulation unit 32) which elapses from the time of input of the required temperature via the manipulation unit 32. The judging unit 333 is configured to judge whether or not the time (elapsed time) from the time of input of the required temperature via the manipulation unit 32 reaches the switching time. In brief, the judging unit 333 is configured to judge whether or not the switching time elapses from the time of input of the required temperature via the manipulation unit 32. Upon acknowledging that the switching time elapses from the time of input of the required temperature via the manipulation unit 32, the judging unit 333 outputs a switching signal to the control unit 334. The judging unit 333 is configured to judge whether or not the switching condition is fulfilled while the control unit 334 performs a first mode to be described.

The control unit 334 is configured to temporarily control the air conditioner 2 to adjust the room temperature to the required temperature until the judging unit 333 judges that the switching time elapses (until receiving the switching signal from the judging unit 333). The control unit 334 is configured to control the air conditioner 2 to adjust the room temperature to the adequate temperature when the judging unit 333 judges that the switching time elapses (upon receiving the switching signal from the judging unit 333). As mentioned in the above, the control unit 334 is configured to perform selectively (alternatively) the first mode of controlling the air conditioner 2 to adjust the room temperature (air temperature) to the required temperature and a second mode of controlling the air conditioner 2 to adjust the room temperature (air temperature) to the adequate temperature. Further, the control unit 334 is configured to, when the required temperature is inputted via the manipulation unit 32, start to perform the first mode. The control unit 334 is configured to, when the manipulation unit 32 judges that the switching condition is fulfilled, end the first mode and start the second mode.

The announcing unit 35 includes a monitor and a speaker and is configured to announce information for relieving dissatisfaction of the user against comfort. For example, the information indicates a message “in order to conserve energy, the current temperature is controlled to a temperature slightly deviated from a temperature range predicted to be comfortable”. When the multiple users exist, the information may indicate a message “x % of users are satisfied with the current temperature”. The monitor displays this information. The speaker outputs this information.

The storage unit 36 is constituted by a ROM (Read Only Memory) or a RAM (Random Access Memory), for example. The storage unit 36 is configured to store the aforementioned information and a program for executing functions by the calculation unit 33.

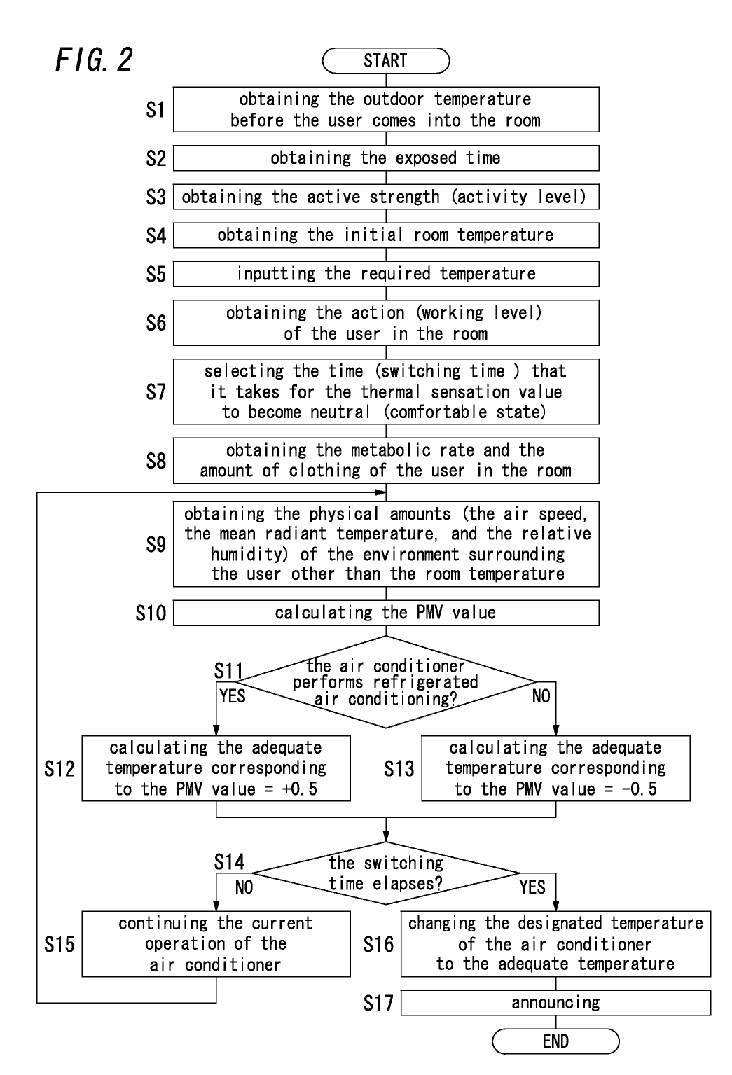

The following explanation referring to FIG. 2 is made to an air-conditioning method employing the air-conditioning system 1 in accordance with the present embodiment. First, the condition setting unit 331 of the air-conditioning control device 3 obtains, from the second temperature sensor 42, the outdoor temperature (exposed temperature) before the user comes into the indoor space (S1 in FIG. 2). Further, the condition setting unit 331 measures the exposed time by use of the opening and closing information from the door sensor 43 and the timer 34 (S2). Moreover, the condition setting unit 331 obtains, from the activity level meter 44, the activity level of the user before the user comes into the indoor space (S3). Thereafter, the condition setting unit 331 obtains the initial room temperature from the first temperature sensor 41 (S4). Next, the required temperature is inputted into the manipulation unit 32 (S5). In other words, the manipulation unit 32 waits for receipt of the required temperature. The working level of the user is inputted into the manipulation unit 32 (S6). After that, the condition setting unit 331 calculates the switching time by use of the outdoor temperature, the exposed time, and the working level (S7). Thereafter, the metabolic rate of the user and the amount of clothing of the user are inputted into the manipulation unit 32 (S8). Subsequently, the adequate temperature setting unit 332 obtains physical amounts (e.g., the air speed, the mean radiant temperature, and the relative humidity) of an environment surrounding the user other than the room temperature (S9). After that, the adequate temperature setting unit 332 calculates the Predicted Mean Vote (PMV) value (S10). When the air conditioner performs refrigerated air conditioning (S11), the adequate temperature setting unit 332 selects a temperature corresponding to the PMV value=+0.5 as the adequate temperature (S12). When the air conditioner performs air heating (S11), the adequate temperature setting unit 332 selects a temperature corresponding to the PMV value=−0.5 as the adequate temperature (S13). Subsequently, the judging unit 333 judges whether or not the switching time elapses (S14). When the switching time does not elapse, the control unit 334 controls the air conditioner 2 to adjust the room temperature to the required temperature (S15). After that, the process is returned to the step S9. When the switching time elapses, the control unit 334 controls the air conditioner 2 to adjust the room temperature to the adequate temperature (S16). Subsequently, the announcing unit 35 announces the information for relieving the user's dissatisfaction against comfort (S17).

As explained in the above, the air-conditioning control method employing the air-conditioning control device 3 of the present embodiment includes a step of receiving a required temperature; a step of calculating the adequate temperature defined as the comfortable temperature for the user in the area on the basis of comfort evaluation; a step of controlling the air conditioner 2 to adjust the air temperature to the required temperature in response to receipt of the desired temperature; a step of judging whether or not the switching condition is fulfilled while the air conditioner 2 is controlled to adjust the air temperature to the required temperature; and a step of controlling the air conditioner 2 to adjust the air temperature to the adequate temperature when the switching condition is fulfilled.

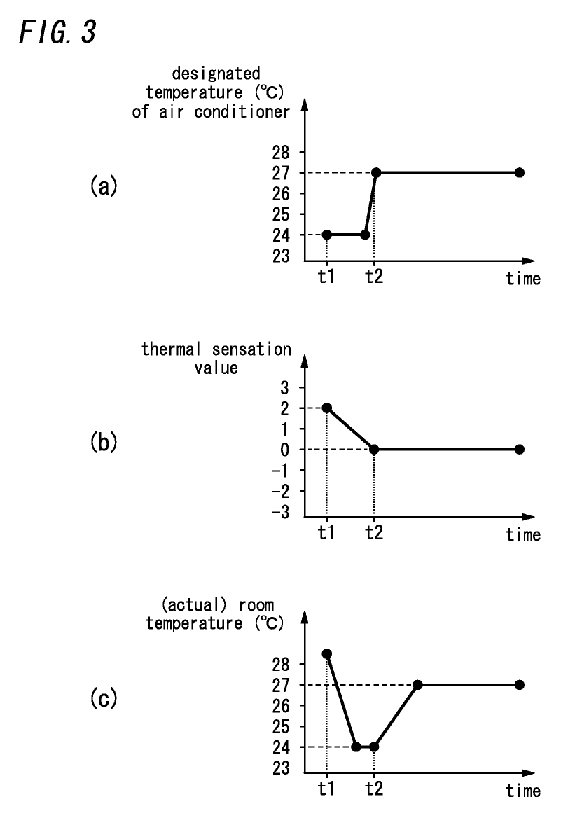

When the aforementioned operation is performed, the designated temperature of the air conditioner 2, the thermal sensation value, and the room temperature are varied as shown in FIG. 3 (a) to (c), respectively. When the required temperature (24° C.) is inputted at the time t1, the room temperature is decreased down to the required temperature (see FIG. 3 (c)). The thermal sensation value comes close to the value (0) indicative of neutral, and reaches 0 at the time t2 (see FIG. 3 (b)). Simultaneously, the adequate temperature is selected as the designated temperature of the air conditioner 2 (see FIG. 3 (a)). Thereafter, the room temperature is increased and is kept at the adequate temperature (see FIG. 3 (c)). The thermal sensation value is maintained identical to the value indicative of neutral after the time t2 (see FIG. 3 (b)).

As described in the above, the air-conditioning control device 3 is configured to control the air conditioner 2 designed to change the air temperature within the area. The air-conditioning control device 3 includes the manipulation unit 32, the adequate temperature setting unit 332, the control unit 334, and the judging unit 333. The manipulation unit 32 is designed for inputting the required temperature. The adequate temperature setting unit 332 is configured to calculate the adequate temperature defined as the comfortable temperature for the user in the area on the basis of the comfort evaluation. The control unit 334 is configured to perform selectively the first mode of controlling the air conditioner 2 to adjust the air temperature to the required temperature and the second mode of controlling the air conditioner 2 to adjust the air temperature to the adequate temperature. The judging unit 333 is configured to judge whether or not the switching condition is fulfilled while the control unit 334 performs the first mode. The control unit 334 is configured to, when the required temperature is inputted via the manipulation unit 32, perform the first mode. The control unit 334 is configured to, when the judging unit judging unit 333 judges that the switching condition is fulfilled, end the first mode and start the second mode.

According to the aforementioned present embodiment, the control unit 334 of the air-conditioning control device 3 temporarily controls the air conditioner 2 to adjust the room temperature to the required temperature, and thereafter controls the air conditioner 2 to keep the room temperature to the adequate temperature. Thus, it is possible to rapidly relieve an uncomfortable situation with reflecting the user's requirement (required temperature), and finally keep the air temperature to the adequate temperature based on the comfort evaluation. In brief, the present embodiment tentatively accepts the required temperature freely selected by the user immediately after the user comes in the indoor space. The present embodiment can automatically change the designated temperature of the air conditioner 2 to the adequate temperature when the metabolism of the user is stabilized and the thermal sensation value becomes the value indicative of neutral. Consequently, the present embodiment can change the condition of the indoor space to objectively high-comfortable condition in a short time.

Further, it is possible to avoid excess cooling (or excess heating) by the air conditioner 2, and therefore the air conditioner 2 can be operated at lowered energy.

Further, the air-conditioning control device 3 of the present embodiment further includes the condition setting unit 331. The condition setting unit 331 is configured to calculate the switching time. The switching time is defined as time which it takes for the user to feel comfortable from the time of input of the required temperature via the manipulation unit 32. The judging unit 333 is configured to, upon acknowledging that the elapsed time from the time of input of the required temperature via the manipulation unit 32 exceeds the switching time, judge that the switching condition is fulfilled. Especially, the adequate temperature setting unit 332 is configured to select, as the adequate temperature, a temperature at which the thermal sensation value of the user becomes the value indicative of neutral. The switching time is defined as time which it takes for the thermal sensation value of the user to become the value indicative of neutral from the time of input of the required temperature via the manipulation unit 32. According to the present embodiment, the condition setting unit 331 modifies the switching condition in accordance with the switching time indicative of timing for change from control of adjusting the room temperature to the required temperature to control of keeping the room temperature to the adequate temperature. Consequently, it is possible to select the optimal switching condition in accordance with the indoor space and/or the condition of the user.

Further, in the air-conditioning control device 3 of the present embodiment, the condition setting unit 331 is configured to adjust the switching time by use of the parameter indicative of external environment of the area. According to the present embodiment, the condition setting unit 331 revises the switching time by use of the parameter indicative of the external environment of the area. It is therefore possible to modify the switching time in conformity with the external environment of the current indoor space.

Further, in the air-conditioning control device 3 of the present embodiment, the condition setting unit 331 is configured to adjust the switching time by use of the working level of the user existing in the area. According to the present embodiment, the condition setting unit 331 revises the switching time by use of the working level of the user. For example, when the user acts actively and feels hot, the condition setting unit 331 can make adjustment of prolonging the switching time. In brief, according to the present embodiment, it is possible to modify the switching time in conformity with the condition of the user.

Further, in the air-conditioning control device 3 of the present embodiment, the condition setting unit 331 is configured to adjust the switching time by use of the activity level of the user existing in the area measured before the user comes into the space. According to the present embodiment, the condition setting unit 331 revises the switching time by use of the activity level of the user measured before the user comes into the indoor space. For example, when the user feels hot after the user acts actively and comes into the indoor space, the condition setting unit 331 can make adjustment of prolonging the switching time. In brief, according to the present embodiment, it is possible to modify the switching time in conformity with the condition of the user.

Further, in the air-conditioning control device 3 of the present embodiment, the adequate temperature setting unit 332 is configured to calculate the temperature range comfortable for the user existing in the area on the basis of the comfort evaluation, and select a temperature from the temperature range as the adequate temperature. According to the present embodiment, a particular temperature of the temperature range determined by the comfort evaluation is adopted as the adequate temperature. It is therefore possible to control the air conditioner 2 to successfully keep the user comfortable. Especially, the adequate temperature setting unit 332 is configured to select, as the adequate temperature, a temperature at which consumption energy of the air conditioner 2 is minimized within the calculated temperature range. The present embodiment adopts, as the adequate temperature, a temperature which is selected from the temperature range determined by use of the comfort evaluation and is defined as the designated temperature at which the consumption energy of the air conditioner 2 is minimized. Consequently, it is possible to more promote the energy conservation of the air conditioner 2.

Further, the air-conditioning control device 3 includes the announcing unit 35 configured to announce, to the user existing in the area, information for relieving dissatisfaction against comfort. According to the present embodiment, since the announcing unit 35 announces the information for relieving the user's dissatisfaction regarding the comfort, it is possible to relieve the user's dissatisfaction.

Besides, in a modification of the present embodiment, the condition setting unit 331 may be configured to adjust the switching time by use of at least one of the parameter (e.g., the outdoor temperature and the exposed time) indicative of the external environment of the indoor space, the working level of the user, and the activity level of the user measured before the user comes into the indoor space. In brief, the condition setting unit 331 does not necessarily use all of the parameter indicative of the external environment of the indoor space, the working level of the user, and the activity level of the user measured before the user comes into the indoor space, in order to adjust the switching time.

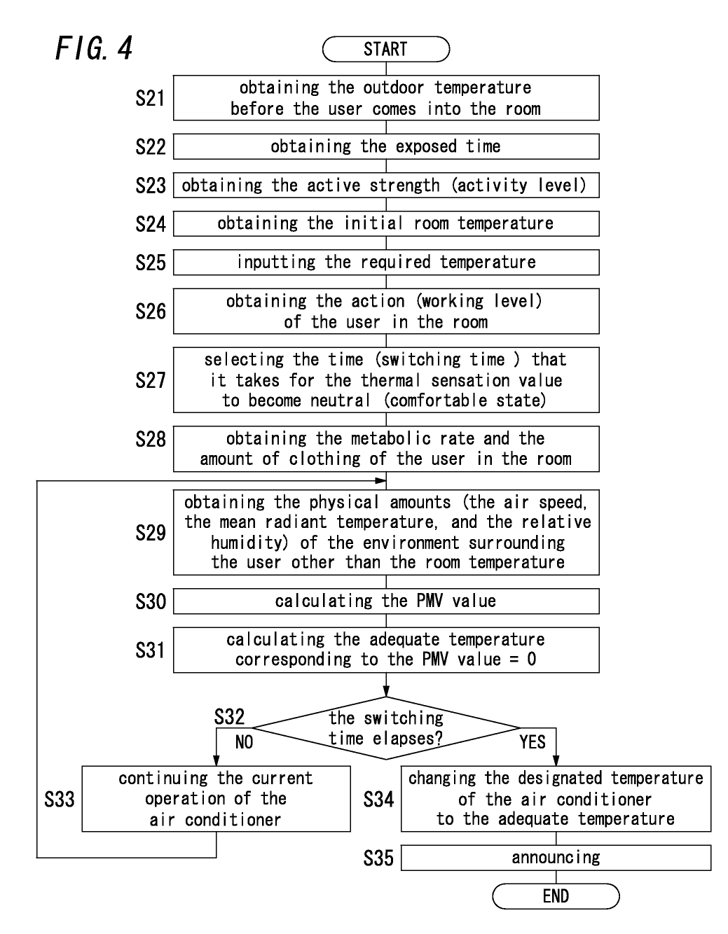

Further, in an alternative modification of the present embodiment, as shown in FIG. 4, the adequate temperature setting unit 332 may be configured to select a temperature corresponding to the PMV value=0 as the adequate temperature (S31 in FIG. 4). Such a modification can be applied to the following second to fourth embodiments. The present modification has steps S21 to S30, and S32 to S35 which are respectively corresponding to the steps S1 to S10, and S14 to S17 of the above present embodiment. Also in the present modification, a particular temperature of the temperature range determined by the comfort evaluation is adopted as the adequate temperature. It is therefore possible to control the air conditioner 2 to successfully keep the user comfortable.

### Second Embodiment

The air-conditioning system 1 in accordance with the second embodiment is different from the air-conditioning system 1 in accordance with the first embodiment in that the switching condition is made without using the switching time. Besides, the air-conditioning system 1 of the present embodiment has the same configurations except the above difference as those of the air-conditioning system 1 of the first embodiment. Like the air-conditioning system 1 of the first embodiment, the air-conditioning system 1 of the present embodiment is illustrated in FIG. 1.

The manipulation unit 32 of the present embodiment is configured to receive biological information of the user. In the present embodiment, a body temperature of the user is used as the biological temperature of the user.

The condition setting unit 331 of the present embodiment does not calculate the switching time but select the switching condition in accordance with biological information of the user. In brief, the condition setting unit 331 calculates, by use of the biological information of the user, the judging value used for judgment of whether or not the switching condition is fulfilled. In the present embodiment, the current thermal sensation value of the user is adopted as the judging value. For example, the condition setting unit 331 is configured to estimate the current thermal sensation value of the user by use of information (e.g., the body temperature of the user) inputted into the manipulation unit 32.

The judging unit 333 of the present embodiment is configured to judge whether or not the thermal sensation value estimated by the condition setting unit 331 is identical to the value indicative of neutral. For example, upon acknowledging that the thermal sensation value estimated by the condition setting unit 331 is identical to the value indicative of neutral, the judging unit 333 outputs the switching signal to the control unit 334. In brief, the judging unit 333 is configured to, upon acknowledging that the current thermal sensation value estimated by the condition setting unit 331 is identical to the value indicative of neutral, judge that the switching condition is fulfilled.

The control unit 334 of the present embodiment is configured to control the air conditioner 2 to adjust the room temperature to the required temperature until the judging unit 333 judges that the thermal sensation value is identical to the value indicative of neutral (until receiving the switching signal from the judging unit 333). In brief, the control unit 334 performs the first control. The control unit 334 is configured to control the air conditioner 2 to adjust the room temperature to the adequate temperature when the judging unit 333 judges that the thermal sensation value is identical to the value indicative of neutral (upon receiving the switching signal from the judging unit 333). In brief, the control unit 334 performs the second control.

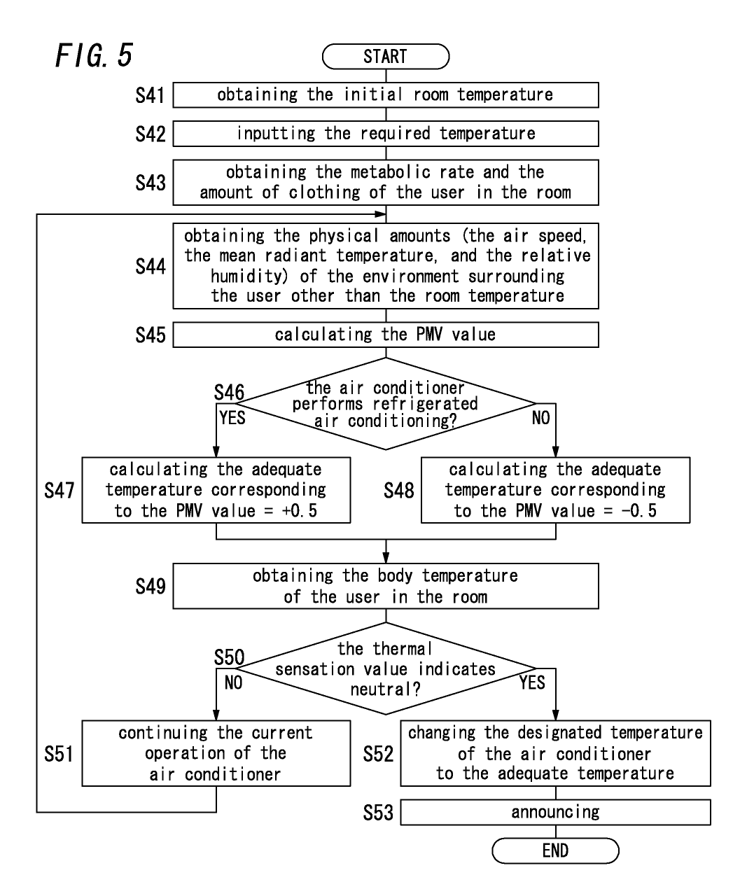

The following explanation referring to FIG. 5 is made to the air-conditioning method employing the air-conditioning system 1 in accordance with the present embodiment. First, the condition setting unit 331 of the air-conditioning control device 3 obtains, from the first temperature sensor 41, the initial room temperature (S41 in FIG. 5). Next, the required temperature is inputted into the manipulation unit 32 (S42). Thereafter, the metabolic rate of the user and the amount of clothing of the user are inputted into the manipulation unit 32 (S43). Subsequently, the adequate temperature setting unit 332 obtains the physical amounts (e.g., the air speed, the mean radiant temperature, and the relative humidity) of the environment surrounding the user other than the room temperature (S44). After that, the adequate temperature setting unit 332 calculates the PMV value (S45). When the air conditioner performs the refrigerated air conditioning (S46), the adequate temperature setting unit 332 selects a temperature corresponding to the PMV value=+0.5 as the adequate temperature (S47). When the air conditioner performs the air heating (S46), the adequate temperature setting unit 332 selects a temperature corresponding to the PMV value=−0.5 as the adequate temperature (S48). Subsequently, the condition setting unit 331 obtains the body temperature of the user (S49). The condition setting unit 331 estimates the thermal sensation value of the user by use of the information indicative of the body temperature of the user. Thereafter, the judging unit 333 judges whether or not the thermal sensation value estimated by the condition setting unit 331 is identical to the value indicative of neutral (S50). When the thermal sensation value is not identical to the value indicative of neutral, the control unit 334 controls the air conditioner 2 to adjust the room temperature to the required temperature (S51). After that, the process is returned to the step S44. When the thermal sensation value is identical to the value indicative of neutral, the control unit 334 controls the air conditioner 2 to keep the room temperature to the adequate temperature (S52). Subsequently, the announcing unit 35 announces the information for relieving the user's dissatisfaction against comfort (S53).

As mentioned in the above, the air-conditioning control device 3 of the present embodiment includes the condition setting unit 331. The condition setting unit 331 is configured to estimate the current thermal sensation value of the user existing in the area. The judging unit 333 is configured to, upon acknowledging that the current thermal sensation value of the user existing in the area estimated by the condition setting unit 331 becomes the value indicative of neutral, judge that the switching condition is fulfilled.

According to the present embodiment, the condition setting unit 331 modifies the switching condition in accordance with the biological information (e.g., the body temperature) of the user. Therefore, it is possible to estimate the user's comfort from the biological information of the user. Consequently, control of adjusting the room temperature to the required temperature can be terminated at adequate timing.

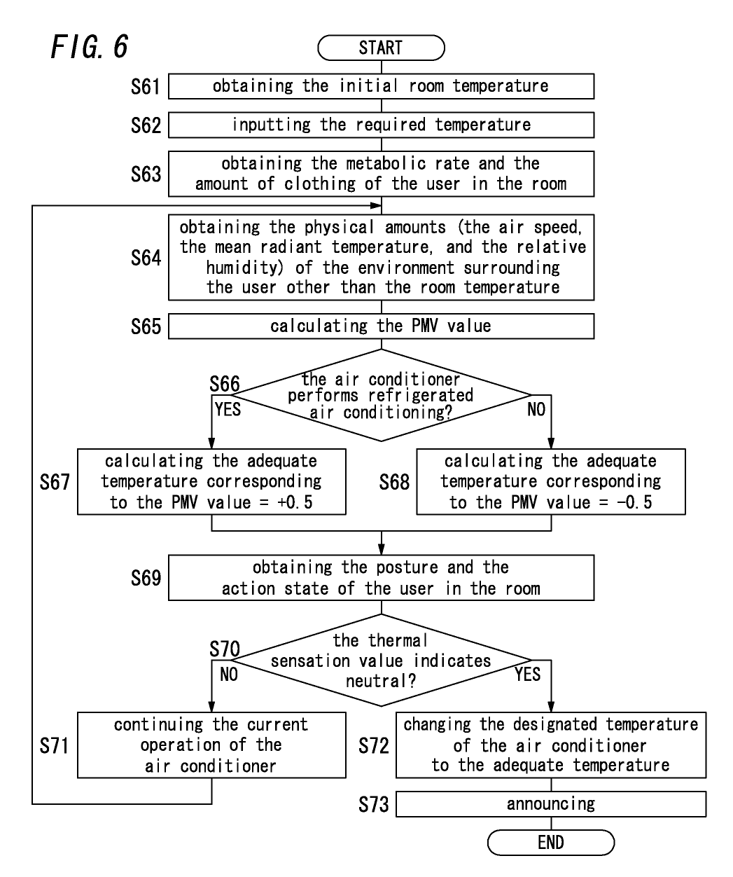

Besides, in a modification of the present embodiment, the biological information of the user may be selected from a posture and an action state of the user. As shown in FIG. 6, the condition setting unit 331 of the present modification obtains the posture or the action state of the user inputted into the manipulation unit 32 (S69 in FIG. 6). The condition setting unit 331 estimates the current thermal sensation value of the user by user of the obtained posture or the action state of the user. The present modification has steps S61 to S68, and S70 to S73 which are respectively corresponding to the steps S41 to S48, and S50 to S53 of the above present embodiment.

### Third Embodiment

The air-conditioning system 1 in accordance with the third embodiment is different from the air-conditioning systems 1 in accordance with the first and second embodiments in that the switching condition different from that of each of the first and second embodiments is used. Besides, the air-conditioning system 1 of the present embodiment has the same configurations except the above difference as those of the air-conditioning system 1 of the first embodiment. Like the air-conditioning system 1 of the first embodiment, the air-conditioning system 1 of the present embodiment is illustrated in FIG. 1.

The manipulation unit 32 of the present embodiment is designed to receive own thermal sensation values from the respective multiple users. The thermal sensation value inputted into the manipulation unit 32 is divided into seven levels (−3, −2, −1, 0, 1, 2, 3). The thermal sensation value is a subjective value of a user.

The condition setting unit 331 of the present embodiment does not calculate the switching time but select the switching condition in accordance with agreement made by a plurality of users existing in the area. In brief, the condition setting unit 331 calculates, by use of the agreement made by the plurality of users, the judging value used for judgment of whether or not the switching condition is fulfilled. In the present embodiment, the judgment value is defined as a ratio of users feeling uncomfortable to all users. For example, the condition setting unit 331 of the present embodiment obtains information (the thermal sensation values of the plurality of the users) inputted into the manipulation unit 32 and then calculates the number of the users for each of the levels (seven levels) of the thermal sensation value. Thereafter, the condition setting unit 331 calculates the ratio of users feeling uncomfortable to all users. In the present embodiment, a user inputting the thermal sensation value less than −2 or not less than +2 is regarded as a user feeling uncomfortable.

The judging unit 333 of the present embodiment is configured to judge whether or not the ratio of users feeling uncomfortable to all users exceeds a predetermined threshold value. For example, upon acknowledging that the ratio of users feeling uncomfortable to all users calculated by the condition setting unit 331 exceeds the predetermined threshold value, the judging unit 333 outputs the switching signal to the control unit 334. In brief, the judging unit 333 is configured to, upon acknowledging that the ratio of users feeling uncomfortable to all users exceeds the threshold value, judge that the switching condition is fulfilled.

The control unit 334 of the present embodiment is configured to control the air conditioner 2 to adjust the room temperature to the required temperature until the judging unit 333 judges that the ratio of users feeling uncomfortable to all users exceeds the predetermined threshold value (until receiving the switching signal from the judging unit 333). In brief, the control unit 334 performs the first control. The control unit 334 is configured to control the air conditioner 2 to keep the room temperature at the adequate temperature when the judging unit 333 judges that the ratio of users feeling uncomfortable to all users exceeds the threshold value (upon receiving the switching signal from the judging unit 333). In brief, the control unit 334 performs the second control.

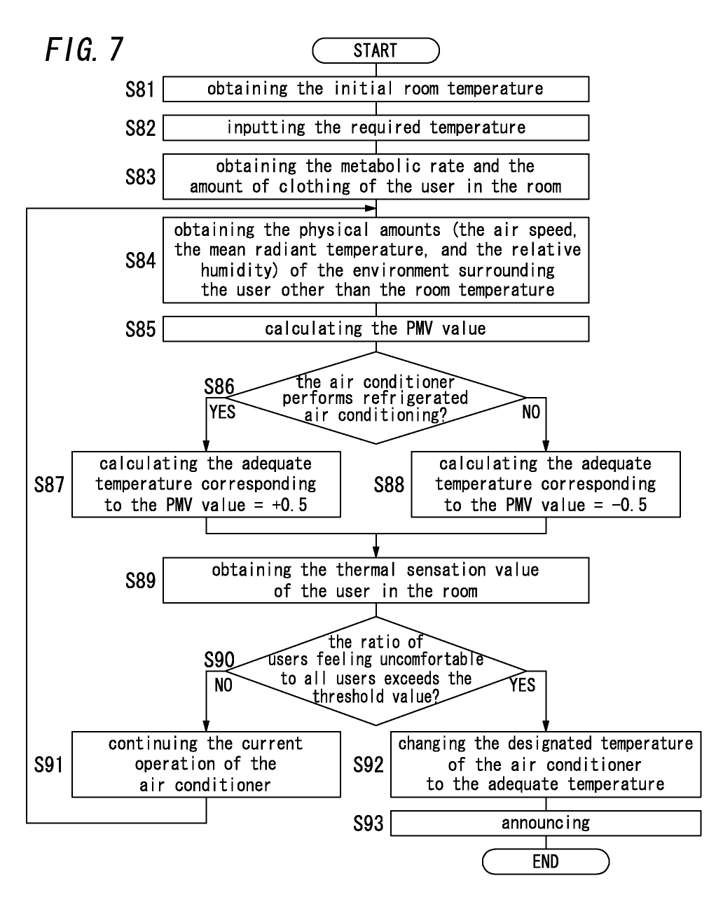

The following explanation referring to FIG. 7 is made to the air-conditioning method employing the air-conditioning system 1 in accordance with the present embodiment. First, the condition setting unit 331 of the air-conditioning control device 3 obtains, from the first temperature sensor 41, the initial room temperature (S81 in FIG. 7). Next, the required temperature is inputted into the manipulation unit 32 (S82). Thereafter, the metabolic rate of the user and the amount of clothing of the user are inputted into the manipulation unit 32 (S83). Subsequently, the adequate temperature setting unit 332 obtains the physical amounts (e.g., the air speed, the mean radiant temperature, and the relative humidity) of the environment surrounding the user other than the room temperature (S84). After that, the adequate temperature setting unit 332 calculates the PMV value (S85). When the air conditioner performs the refrigerated air conditioning (S86), the adequate temperature setting unit 332 selects a temperature corresponding to the PMV value=+0.5 as the adequate temperature (S87). When the air conditioner performs the air heating (S86), the adequate temperature setting unit 332 selects a temperature corresponding to the PMV value=−0.5 as the adequate temperature (S88). Subsequently, the condition setting unit 331 obtains the thermal sensation value with regard to the plurality of the users (S89). Thereafter, the judging unit 333 judges whether or not the ratio of users feeling uncomfortable to all users exceeds the threshold value (S90). When the ratio of users feeling uncomfortable to all users does not exceed the threshold value, the control unit 334 controls the air conditioner 2 to adjust the room temperature to the required temperature (S91). After that, the process is returned to the step S84. When the ratio of users feeling uncomfortable to all users exceeds the threshold value, the control unit 334 controls the air conditioner 2 to keep the room temperature at the adequate temperature (S92). Subsequently, the announcing unit 35 announces the information for relieving the user's dissatisfaction against comfort (S93).

As mentioned in the above, the air-conditioning control device 3 of the present embodiment includes the condition setting unit 331. The condition setting unit 331 is configured to calculate the ratio of users feeling uncomfortable to all users. The judging unit 333 is configured to, upon acknowledging that the ratio of users feeling uncomfortable to all users calculated by the condition setting unit 331 exceeds the threshold value, judge that the switching condition is fulfilled.

According to the present embodiment, the condition setting unit 331 modifies the switching condition in accordance with the agreement made by the plurality of the users. Therefore, it is possible to estimate the comfort of the plurality of the users from the agreement made by the users. Consequently, even when the plurality of the users exists in the indoor space, it is possible to perform control of improving the comfort.

### Fourth Embodiment

The air-conditioning system 1 in accordance with the fourth embodiment is different from the air-conditioning system 1 in accordance with the third embodiment in that a future thermal sensation value is estimated. Besides, the air-conditioning system 1 of the present embodiment has the same configurations except the above difference as those of the air-conditioning system 1 of the third embodiment. Like the air-conditioning system 1 of the third embodiment, the air-conditioning system 1 of the present embodiment is illustrated in FIG. 1. However, in the following explanation of the present embodiment, the number of the users is one.

The manipulation unit 32 of the present embodiment is designed to receive the own thermal sensation value from the user. The thermal sensation value inputted into the manipulation unit 32 is divided into seven levels (−3, −2, −1, 0, 1, 2, 3). The thermal sensation value is a subjective value of the user.

The condition setting unit 331 of the present embodiment obtains the information (the thermal sensation value of the user) inputted into the manipulation unit 32, and then estimates the future thermal sensation value. First, the condition setting unit 331 estimates following time (hereinafter referred to as “room temperature following time”) corresponding to a situation where the designated temperature of the air conditioner 2 is changed to the adequate temperature at the current time. The room temperature following time is defined as time which it takes for the room temperature (air temperature) to reach the adequate temperature after the designated temperature of the air conditioner 2 is changed from the required temperature to the adequate temperature. Subsequently, the condition setting unit 331 estimates the thermal sensation value (the thermal sensation of the user at the time when the air temperature becomes the adequate temperature) of the user at the time when the room temperature following time elapses after the designated temperature of the air conditioner 2 is changed to the adequate temperature.

The judging unit 333 of the present embodiment is configured to judge whether or not the thermal sensation value estimated by the condition setting unit 331 is identical to the value (0) indicative of neutral. Upon acknowledging that the thermal sensation value estimated by the condition setting unit 331 is identical to the value indicative of neutral, the judging unit 333 of the present embodiment outputs the switching signal to the control unit 334. In brief, the judging unit 333 is configured to, upon acknowledging that the thermal sensation value estimated by the condition setting unit 331 is identical to the value indicative of neutral, judge that the switching condition is fulfilled.

The air-conditioning control device 3 of the present embodiment changes the designated temperature of the air conditioner 2 from the required temperature to the adequate temperature such that the thermal sensation value of the user becomes the value indicative of neutral just when the air temperature (room temperature) becomes the adequate temperature.

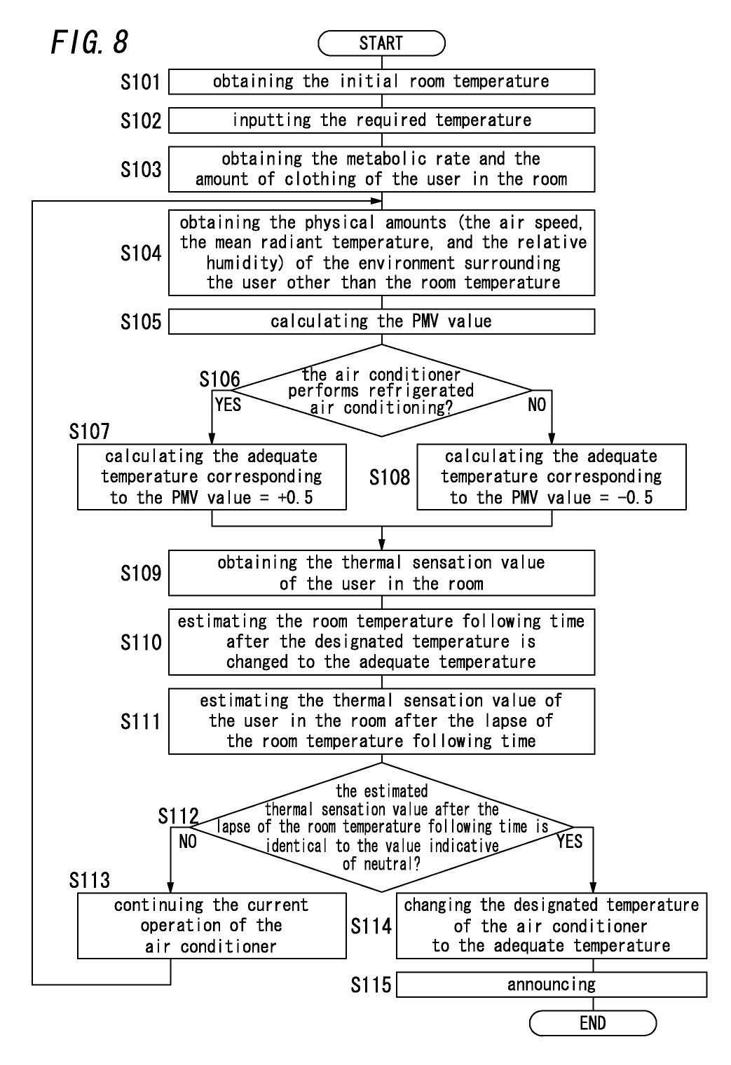

The following explanation referring to FIG. 8 is made to the air-conditioning method employing the air-conditioning system 1 in accordance with the present embodiment. First, the steps S81 to S88 explained in the third embodiment are performed (S101 to S108 in FIG. 8). Thereafter, the condition setting unit 331 obtains the thermal sensation value of the user (S109). After that, the condition setting unit 331 estimates the room temperature following time corresponding to a situation where the designated temperature of the air conditioner 2 is changed to the adequate temperature at the current time (S110). Subsequently, the condition setting unit 331 estimates the thermal sensation value of the user at the time when the room temperature following time elapses (S111). Next, the judging unit 333 judges whether or not the estimated thermal sensation value is identical to the value indicative of neutral (S112). When the estimated thermal sensation value is not identical to the value indicative of neutral, the control unit 334 controls the air conditioner 2 to adjust the room temperature to the required temperature (S113). After that, the process is returned to the step S109. When the estimated thermal sensation value is identical to the value indicative of neutral, the control unit 334 controls the air conditioner 2 to keep the room temperature at the adequate temperature (S114). Subsequently, the announcing unit 35 announces the information for relieving the user's dissatisfaction against comfort (S115).

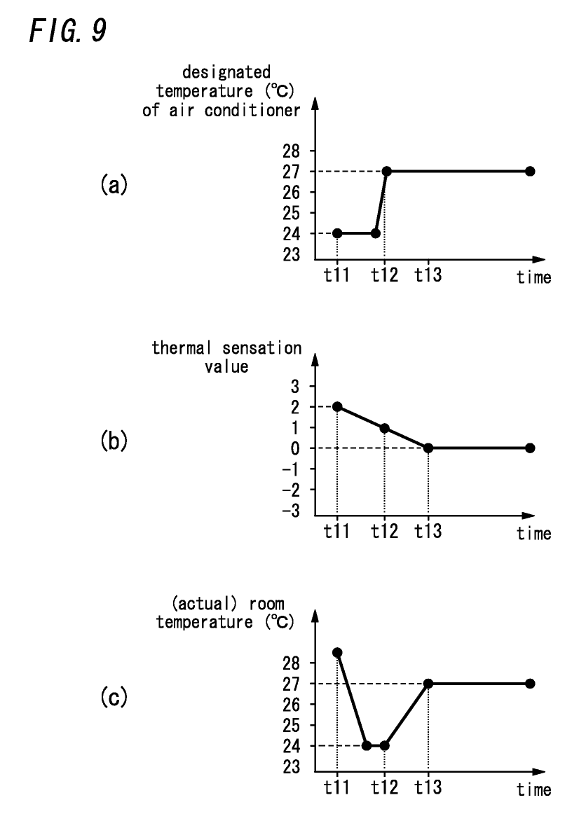

When the aforementioned operation is performed, the designated temperature of the air conditioner 2, the thermal sensation value, and the room temperature are varied as shown in FIG. 9 (a) to (c), respectively. When the required temperature (24° C.) is inputted at the time t11, the room temperature is decreased and reaches the required temperature (see FIG. 9 (c)). Since the estimated thermal sensation value becomes the value (0) indicative of neutral, the designated temperature of the air conditioner 2 is changed to the adequate temperature at the time t12 (see FIG. 9 (a)). Subsequently, the room temperature is increased and is kept at the adequate temperature after the time t13 (see FIG. 9 (c)). Also the thermal sensation value is maintained identical to the value indicative of neutral after the time t3 (see FIG. 9 (b)).

As mentioned in the above, the present embodiment can estimate the future thermal sensation value from the current thermal sensation value. It is therefore possible to improve the comfort.

### Fifth Embodiment

The air-conditioning system 1 in accordance with the fifth embodiment is different from the air-conditioning system 1 in accordance with the first embodiment in that the other comfort evaluation is used. Besides, the air-conditioning system 1 of the present embodiment has the same configurations except the above difference as those of the air-conditioning system 1 of the first embodiment. Like the air-conditioning system 1 of the first embodiment, the air-conditioning system 1 of the present embodiment is illustrated in FIG. 1.

The adequate temperature setting unit 332 of the present embodiment employs the comfort evaluation other than the Predicted Mean Vote (PMV). For example, the other comfort evaluation may be selected from the discomfort index (DI), the operative temperature (OT), the effective temperature (ET), the corrected effective temperature (CET), the new effective temperature (ET*), the standard new effective temperature (SET*), and the wet bulb globe temperature (WBGT).

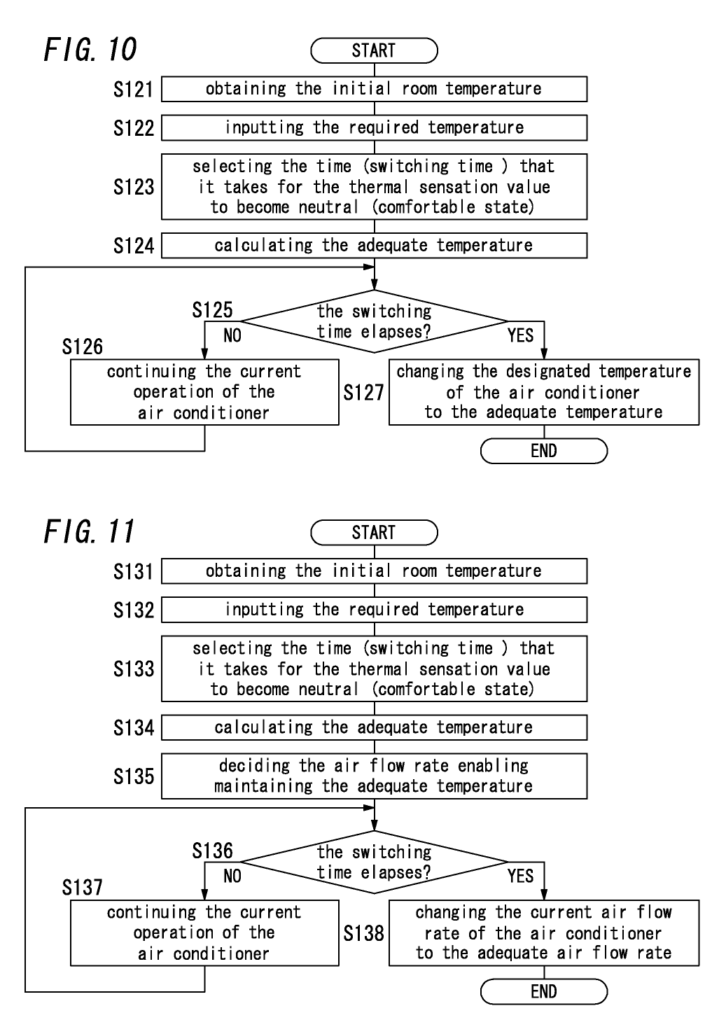

The following explanation referring to FIG. 10 is made to the air-conditioning method employing the air-conditioning system 1 in accordance with the present embodiment. First, the condition setting unit 331 of the air-conditioning control device 3 obtains, from the first temperature sensor 41, the initial room temperature (S121 in FIG. 10). Next, the required temperature is inputted into the manipulation unit 32 (S122). Thereafter, the condition setting unit 331 selects the switching time (S123). After that, the adequate temperature setting unit 332 calculates the adequate temperature by use of the comfort evaluation (S124). Next, the judging unit 333 judges whether or not the switching time elapses (S125). When the switching time does not elapse, the control unit 334 controls the air conditioner 2 to adjust the room temperature to the required temperature (S126). After that, the process is returned to the step S125. When the switching time elapses, the control unit 334 controls the air conditioner 2 to keep the room temperature at the adequate temperature (S127).

As mentioned in the above, also in the present embodiment, the control unit 334 of the air-conditioning control device 3 temporarily controls the air conditioner 2 to adjust the room temperature to the required temperature, and thereafter controls the air conditioner 2 to keep the room temperature at the adequate temperature. Thus, it is possible to rapidly relieve the initial uncomfortable situation with reflecting the user's requirement (required temperature), and finally keep the air temperature to the adequate temperature based on the comfort evaluation. Consequently, the present embodiment can change the condition of the indoor space to objectively high-comfortable condition in a short time, and to promote the energy conservation of the air conditioner 2.

As mentioned in the above, also in the present embodiment, the control unit 334 of the air-conditioning control device 3 temporarily controls the air conditioner 2 to adjust the room temperature to the required temperature, and thereafter controls the air conditioner 2 to keep the room temperature at the adequate temperature. Thus, it is possible to rapidly relieve the uncomfortable situation with reflecting the user's requirement (required temperature), and finally keep the air temperature to the adequate temperature based on the comfort evaluation. Consequently, the present embodiment can change the condition of the indoor space to objectively high-comfortable condition in a short time.

Further, it is possible to avoid excess cooling (or excess heating) by the air conditioner 2, and therefore the air conditioner 2 can be operated at lowered energy.

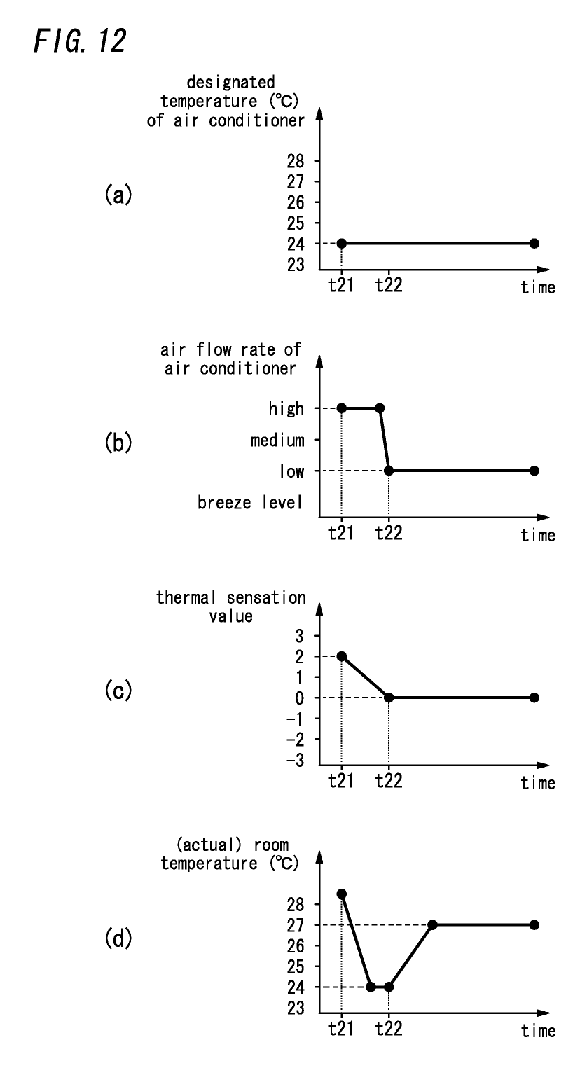

Besides, in a modification of the present embodiment, as shown in FIG. 11, the control unit 334 may be configured to adjust an air flow rate of the air conditioner 2 instead of the designated temperature of the air conditioner 2 (S135 and S138 in FIG. 11). The present modification has steps S131 to S134, S136, and S137 which are respectively corresponding to the steps S121 to S126 of the above present embodiment. In the present modification, the designated temperature of the air conditioner 2, the air flow rate of the air conditioner 2, the thermal sensation value, and the room temperature are varied as shown in FIG. 12 (a) to (d), respectively. When the required temperature is inputted at the time t21, the air conditioner 2 operates with the high air flow rate (see FIG. 12 (b)). The room temperature is decreased and reaches the required temperature (see FIG. 12 (d)). The thermal sensation value comes close to the value (0) indicative of neutral, and reaches 0 at the time t22 (see FIG. 12 (c)). Simultaneously, the air flow rate of the air conditioner 2 is changed to an adequate air flow rate (low) (see FIG. 12 (b)). Thereafter, the room temperature is increased and is kept at the adequate temperature (see FIG. 12 (d)). The thermal sensation value is maintained identical to the value indicative of neutral after the time t22 (see FIG. 12 (c)). In the present modification, the designated temperature of the air conditioner 2 is kept at the required temperature (see FIG. 12 (a)). When the adequate air flow rate preliminarily selected is insufficient to adjust the room temperature to the adequate temperature, the air-conditioning control device 3 of the present modification may measure the actual room temperature and perform feedback control of the adequate air flow rate based on the measured actual room temperature.

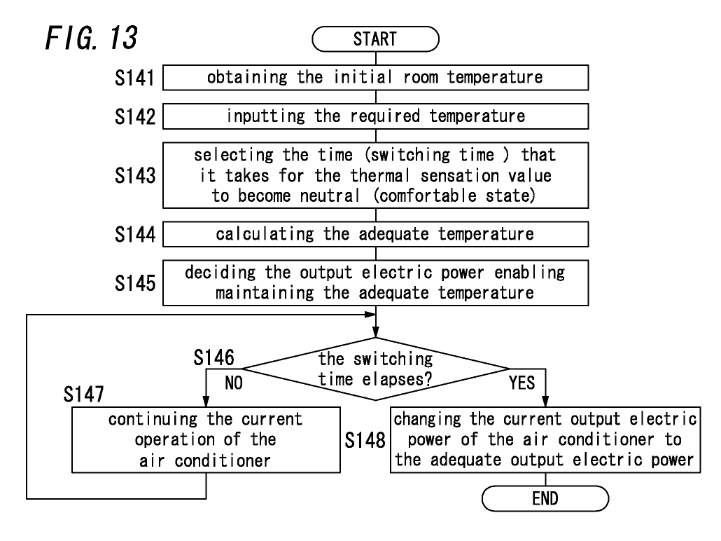

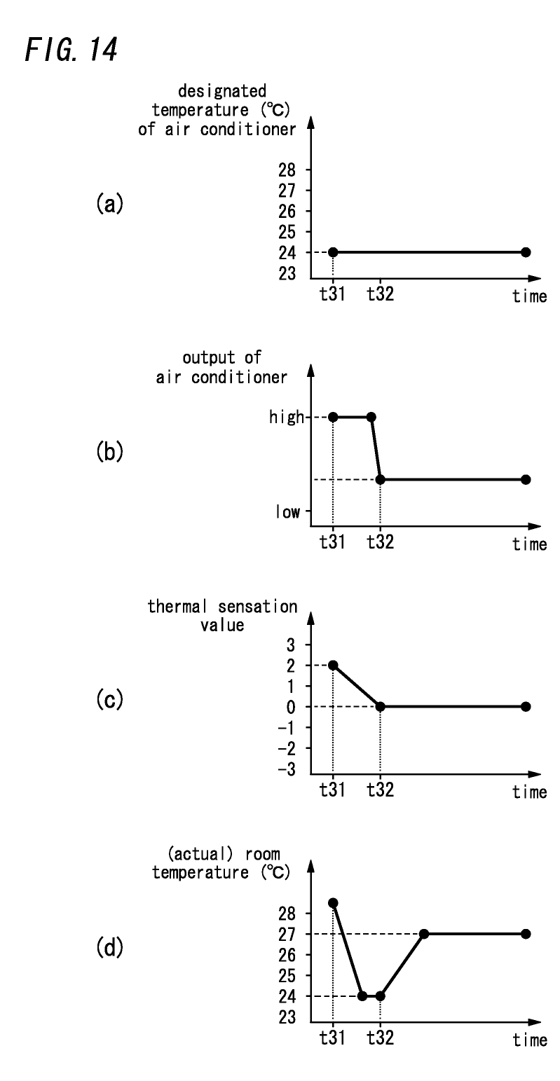

Besides, in another modification of the present embodiment, as shown in FIG. 13, the control unit 334 may be configured to adjust output electric power of the air conditioner 2 instead of the designated temperature of the air conditioner 2 (S145 and S148 in FIG. 13). The present modification has steps S141 to S144, S146, and S147 which are respectively corresponding to the steps S121 to S126 of the above present embodiment. In the present modification, the designated temperature of the air conditioner 2, the output electric power of the air conditioner 2, the thermal sensation value, and the room temperature are varied as shown in FIG. 14 (a) to (d), respectively. When the required temperature is inputted at the time t31, the air conditioner 2 operates with the high output electric power (see FIG. 14 (b)). The room temperature is decreased and reaches the required temperature (see FIG. 14 (d)). The thermal sensation value comes close to the value (0) indicative of neutral, and reaches 0 at the time t32 (see FIG. 14 (c)). Simultaneously, the output electric power of the air conditioner 2 is changed to adequate electric power, and becomes less than the previous output electric power (see FIG. 14 (b)). Thereafter, the room temperature is increased and is kept at the adequate temperature (see FIG. 14 (d)). The thermal sensation value is maintained identical to the value indicative of neutral (see FIG. 14 (c)). In the present modification, the designated temperature of the air conditioner 2 is kept at the required temperature (see FIG. 14 (a)). When the adequate output electric power preliminarily selected is insufficient to adjust the room temperature to the adequate temperature, the air-conditioning control device 3 of the present modification may measure the actual room temperature and perform feedback control of the adequate output electric power based on the measured actual room temperature.

Besides, the function of selecting the adequate temperature based on the other comfort evaluation and the function of controlling the air flow rate or the output electric power of the air conditioner 2 of the present embodiment may be applied to any one of the air-conditioning systems 1 of the second to fourth embodiments and corresponding modifications.

### Sixth Embodiment

The air-conditioning system 1 in accordance with the sixth embodiment is different from the air-conditioning system 1 in accordance with the fifth embodiment in that the adequate temperature is renewed. Besides, the air-conditioning system 1 of the present embodiment has the same configurations except the above difference as those of the air-conditioning system 1 of the fifth embodiment. Like the air-conditioning system 1 of the fifth embodiment, the air-conditioning system 1 of the present embodiment is illustrated in FIG. 1.

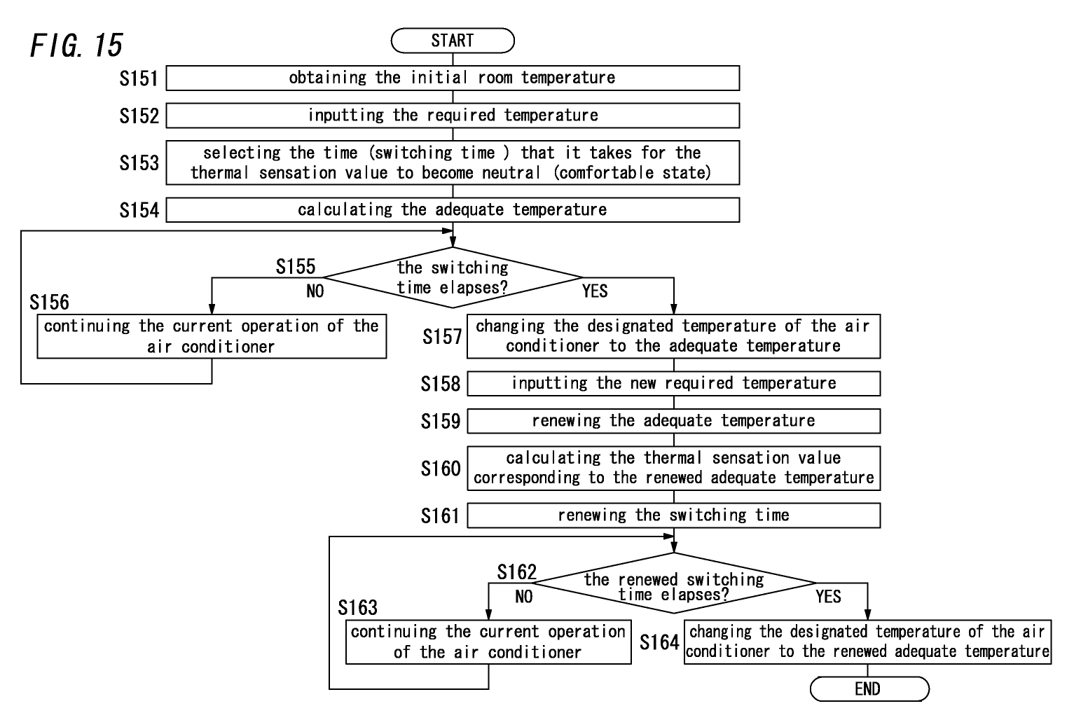

In the present embodiment, as shown in FIG. 15, the control unit 334 controls the air conditioner 2 to keep the room temperature at the adequate temperature (S157 in FIG. 15). After that, when the required temperature is newly inputted into the manipulation unit 32 (S158), the manipulation unit 32 renews the adequate temperature in accordance with preference (new requirement) of the user (S159). Thereafter, the condition setting unit 331 calculates the thermal sensation value corresponding to the renewed adequate temperature (S160), and selects, as the renewed switching time, time which it takes for the thermal sensation value of the user to become the calculated thermal sensation value (S161). Subsequently, the judging unit 333 judges whether or not the renewed switching time elapses (S162). When the switching time does not elapse, the control unit 334 controls the air conditioner 2 to adjust the room temperature to the required temperature (S15). After that, the process is returned to the step S162. When the switching time elapses, the control unit 334 controls the air conditioner 2 to adjust the room temperature to the adequate temperature (S164). Besides, the steps S151 to S157 are respectively corresponding to the steps S121 to S127 of the fifth embodiment.

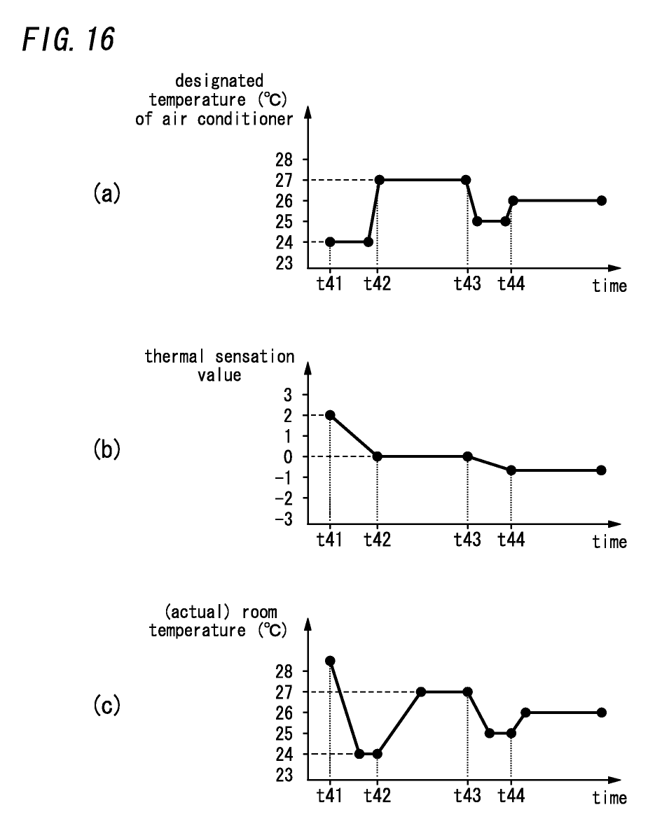

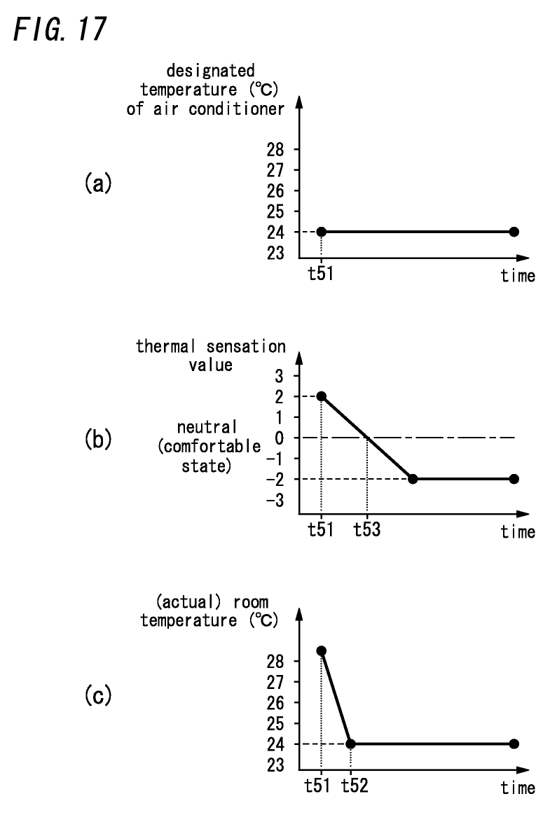

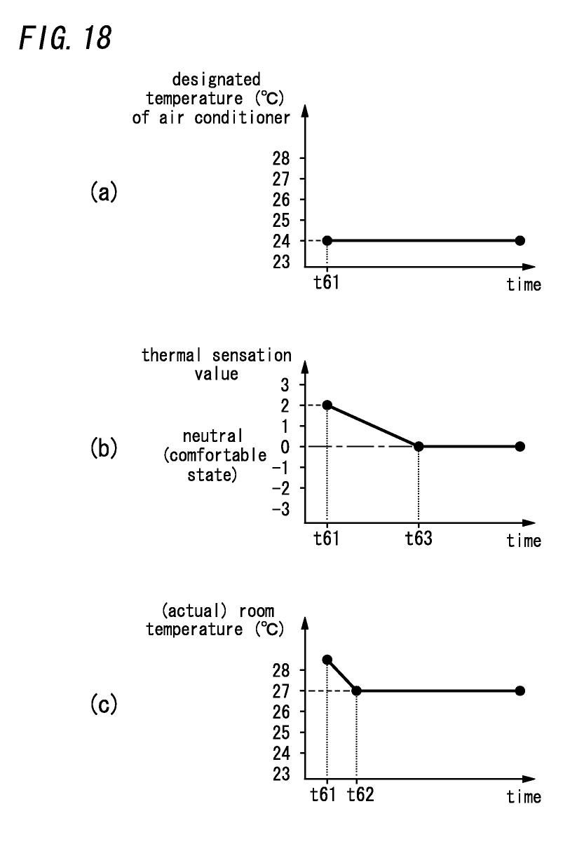

When the aforementioned operation is performed, the designated temperature of the air conditioner 2, the thermal sensation value, and the room temperature are varied as shown in FIG. 16 (a) to (c), respectively. When the required temperature (24° C.) is inputted at the time t41, the room temperature is decreased down and reaches the required temperature (see FIG. 16 (c)). The thermal sensation value comes close to the value (0) indicative of neutral, and reaches 0 at the time t42 (see FIG. 16 (b)). Simultaneously, the adequate temperature is selected as the designated temperature of the air conditioner 2 (see FIG. 16 (a)). Thereafter, the room temperature is increased up and is kept at the adequate temperature (see FIG. 16 (c)). The thermal sensation value is maintained identical to the value indicative of neutral (see FIG. 16 (b)). When the required temperature (25° C.) is newly inputted at the time t43, the designated temperature of the air conditioner 2 is changed to the new required temperature (see FIG. 16 (a)). The room temperature is decreased down and reaches the new required temperature (see FIG. 16 (c)). The thermal sensation value becomes lower than the value indicative of neutral (see FIG. 16 (b)). Thereafter, the designated temperature of the air conditioner 2 is changed to the adequate temperature newly calculated, at the time t44 (see FIG. 16 (a)). Subsequently, the room temperature is increased up and is kept at the adequate temperature newly calculated (see FIG. 16 (0).

As described in the above, the present embodiment can automatically adjust the adequate temperature in accordance with the preference of the user, even after the adequate temperature is selected. In brief, according to the present embodiment, when the required temperature is inputted again, it is possible to newly select the adequate temperature in which the preference of the user is reflected.

Besides, the function of renewing the adequate temperature provided to the present embodiment may be applied to any one of the air-conditioning systems 1 of the second to fourth embodiments and corresponding modifications.

1. An air-conditioning control device for controlling an air conditioner designed to change an air temperature within an area, said air-conditioning control device comprising:
a manipulation unit designed for inputting a required temperature;
an adequate temperature setting unit configured to calculate an adequate temperature defined as a comfortable temperature for a user in the area on the basis of comfort evaluation;
a control unit configured to perform selectively a first mode of controlling the air conditioner to adjust the air temperature to the required temperature and a second mode of controlling the air conditioner to adjust the air temperature to the adequate temperature; and
a judging unit configured to judge whether or not a switching condition is fulfilled while said control unit performs said first mode,
wherein said control unit is configured to, when the required temperature is inputted via said manipulation unit, perform the first mode, and
said control unit is configured to, when said judging unit judges that the switching condition is fulfilled, end the first mode and start the second mode.

2. An air-conditioning control device as set forth in claim 1, wherein
said air-conditioning control device further comprises a condition setting unit, and
said condition setting unit is configured to calculate a switching time, and
the switching time is defined as time which it takes for the user to feel comfortable from the time of input of the required temperature via said manipulation unit, and
said judging unit is configured to, upon acknowledging that elapsed time from the time of input of the required temperature via said manipulation unit exceeds the switching time, judge that the switching condition is fulfilled.

3. An air-conditioning control device as set forth in claim 2, wherein
said adequate temperature setting unit is configured to select, as the adequate temperature, a temperature at which a thermal sensation value of the user becomes a value indicative of neutral, and
the switching time is defined as time which it takes for the thermal sensation value of the user to become the value indicative of neutral from the time of input of the required temperature via said manipulation unit.

4. An air-conditioning control device as set forth in claim 2, wherein
said condition setting unit is configured to adjust the switching time by use of a parameter indicative of external environment of the area.

5. An air-conditioning control device as set forth in claim 2, wherein
said condition setting unit is configured to adjust the switching time by use of a working level of the user existing in the area.

6. An air-conditioning control device as set forth in claim 2, wherein
said condition setting unit is configured to adjust the switching time by use of an activity level of the user existing in the area.

7. An air-conditioning control device as set forth in claim 1, wherein
said air-conditioning control device further comprises a condition setting unit, and
said condition setting unit is configured to select the switching condition in accordance with biological information of the user existing in the area.

8. Air-conditioning control device as set forth in claim 1, wherein
said air-conditioning control device further comprises a condition setting unit, and
said condition setting unit is configured to estimate a current thermal sensation value of the user existing in the area, and
said judging unit is configured to, upon acknowledging that the current thermal sensation value of the user existing in the area estimated by said condition setting unit becomes a value indicative of neutral, judge that the switching condition is fulfilled.

9. An air-conditioning control device as set forth in claim 1, wherein
said air conditioning control device further comprises a condition setting unit configured to select the switching condition in accordance with agreement made by a plurality of users existing in the area.

10. Air-conditioning control device as set forth in claim 1, wherein
said air-conditioning control device further comprises a condition setting unit, and
said condition setting unit is configured to calculate a ratio of users feeling uncomfortable to all users, and
said judging unit is configured to, upon acknowledging that the ratio of users feeling uncomfortable to all users calculated by said condition setting unit exceeds a threshold value, judge that the switching condition is fulfilled.

11. An air-conditioning control device as set forth in claim 1, wherein
said adequate temperature setting unit is configured to calculate a temperature range comfortable for the user existing in the area on the basis of the comfort evaluation, and select a temperature from the temperature range as the adequate temperature.

12. An air-conditioning control device as set forth in claim 11, wherein
said adequate temperature setting unit is configured to select, as the adequate temperature, a temperature at which consumption energy of the air conditioner is minimized within the temperature range.

13. An air-conditioning control device as set forth in claim 1, wherein
said air-conditioning control device further comprises an announcing unit configured to announce, to the user existing in the area, information for relieving dissatisfaction against comfort.

14. An air-conditioning system comprising:
an air conditioner designed to change an air temperature within an area; and
an air-conditioning control device configured to control said air conditioner,
wherein said air-conditioning control device is defined by claim 1.

15. An air-conditioning control method for controlling an air conditioner designed to change an air temperature within an area, said method comprising the steps of:
receiving a required temperature;
calculating an adequate temperature defined as a comfortable temperature for a user in the area on the basis of comfort evaluation;
controlling the air conditioner to adjust the air temperature to the required temperature in response to receipt of the desired temperature;
judging whether or not a switching condition is fulfilled while the air conditioner is controlled to adjust the air temperature to the required temperature; and
controlling the air conditioner to adjust the air temperature to the adequate temperature when the switching condition is fulfilled.
